(19) United States
(12) Patent Application Publication
(10) Pub. No.: US 2015/0303509 A1
(43) Pub. Date: Oct. 22, 2015

(54) BATTERY MODULE

(71) Applicant: SANYO ELECTRIC CO., LTD, Osaka (JP)

(72) Inventor: MITSUTOSHI TAJIMA, Hyogo (JP)

(21) Appl. No.: 14/646,735

(22) PCT Filed: Nov. 13, 2013
(86) PCT No.: PCT/JP2013/006668

§ 371 Date: May 22, 2015

(30) Foreign Application Priority Data
Nov. 28, 2012 (JP) 2012-260180

(51) Int. Cl. H01M 10/04

(52) U.S. Cl. CPC H01M 10/0468

(57) ABSTRACT

A battery module has a stacked member including a plurality of batteries, separators provided at the batteries, and a pair of the end plates disposed at both ends of the stacked direction of the plurality of the batteries. Binding bars are fixed to the pair of the end plates so as to bind the plurality of the batteries. When temperature changes from 30° C. to −30° C., the binding bars have larger compressed size change ΔL per unit length in the elongated direction than compressed size change ΔS per unit length in the stacked direction in the stacked member

### TECHNICAL FIELD

The present invention is related to a battery module in which a plurality of batteries are connected.

### BACKGROUND ART

Generally, in a battery module in which a plurality of batteries are connected, a pair of end plates are disposed at both ends in the stacked direction of the plurality of the battery, and a binding member such as a binding bar or a rod is fixed to the pair of the end plates, and then in this structure the plurality of the batteries are bound.

### CITATION LIST

### Patent Literature

Patent Literature 1: Japanese Laid-Open Patent Publication No. 2010-157450

### SUMMARY OF THE INVENTION

In a conventional module, under a low temperature condition at the time of starting the operation of the battery module, there is the following problem. Swelling strength in a stacked member including the batteries and the end plates are decreased, and binding strength by the binding member is decreased, and then the vibration resistance is decreased.

The present disclosure is developed for the purpose of solving such problem. One non-limiting and explanatory embodiment provides a technology of a battery module in which the decrease of the binding strength to a battery stacked member by a binding member can be suppressed under a low temperature condition.

A battery module of the present disclosure comprises a stacked member containing a plurality of batteries stacked in one direction, and a binding member for binding the stacked member in the stacked direction in a pressurized state, and further the stacked member comprises temperature deformed member of which size changes by change of temperature, and compressed member bound by the binding member in a compressed state, and in the temperature range of at least 30° C. to 30° C., the binding member has larger compressed size change per unit temperature in the stacked direction of ΔL/ΔT than compressed size change per unit temperature in the stacked direction of ΔS/ΔT in the temperature deformed member.

In the present invention, the decrease of the binding strength to a battery stacked member by a binding member can be suppressed under a low temperature condition.

### BRIEF DESCRIPTION OF DRAWINGS

FIG. 1 is a perspective view showing a schematic structure of a battery module related to an embodiment.

FIG. 2 is a view showing the battery module related to the embodiment, and (A) is a plan view, and (B) is a side view, and (C) is a front view, respectively showing the battery module.

FIG. 3 is a sectional view showing a schematic structure of a battery.

FIG. 4 is a graph showing changes in binding strength by binding bar when temperature is changed from 30° C. to −30° C.

### DESCRIPTION OF EMBODIMENTS

An embodiment of the present invention is explained in the following, by referring the figures. Here, in all the figures, the same configuration elements are marked with the like reference marks, and those explanation are properly omitted.

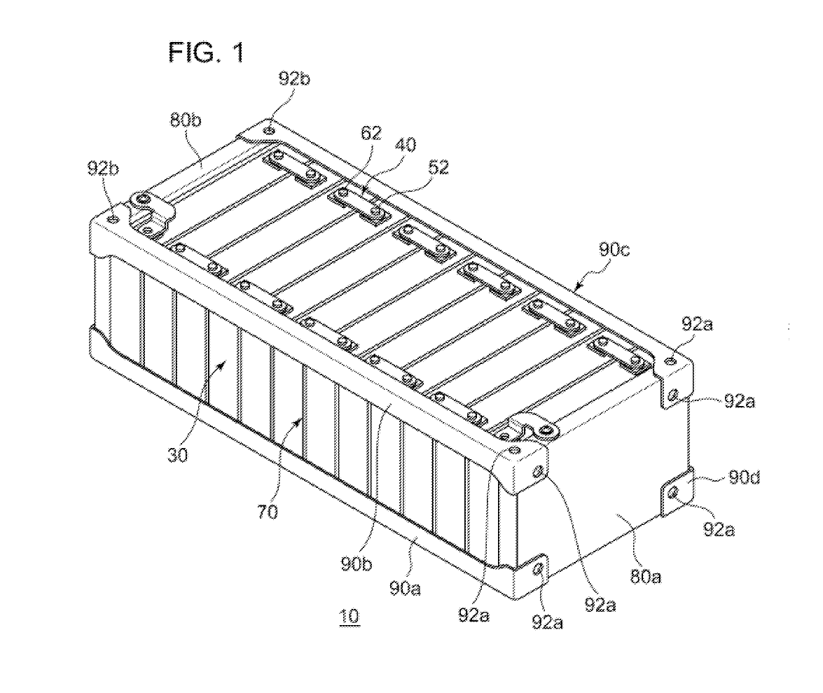

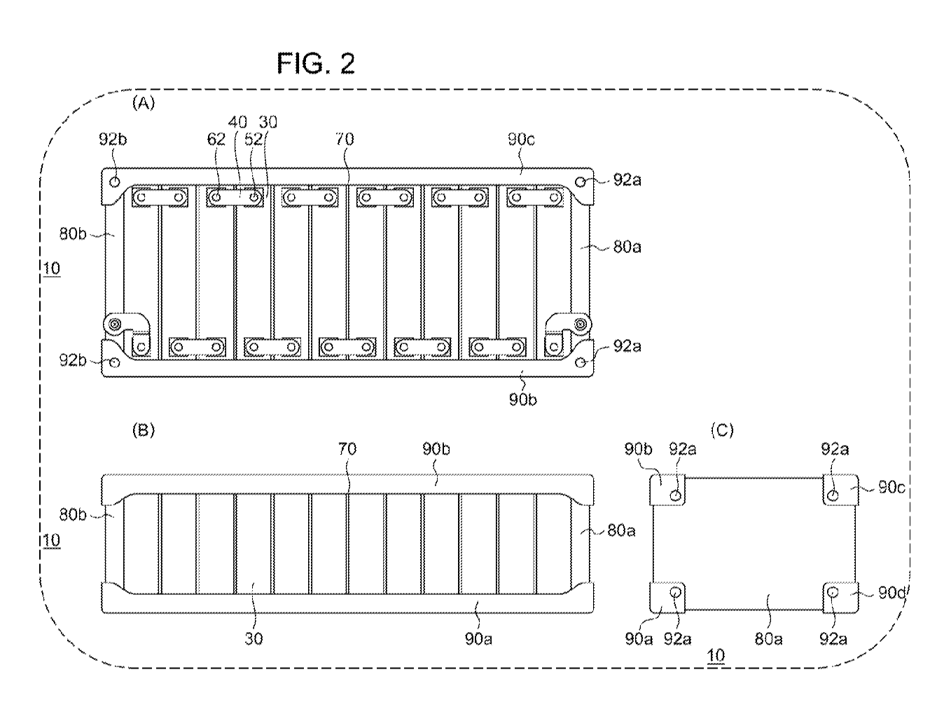

FIG. 1 is a perspective view showing a schematic structure of a battery module related to an embodiment. FIG. 2 is a view showing the battery module related to the embodiment, and (A) is a plan view, and (B) is a side view, and (C) is a front view, respectively showing the battery module. As shown in FIG. 1 and FIG. 2, the battery module 10 includes bus bars 40, separators 70, end plates 80, binding bars (rods) 90. In this embodiment, total 12 pieces of batteries 30 are connected in series to form a battery group. Here, a number of the batteries 30 is not limited to specific one. In this embodiment, all of the 12 pieces of the batteries 30 are connected in series, but those may be partially connected in parallel. Between adjacent batteries 30, the separators 70 made of insulating resin such as PP (polypropylene) or PBT (polybutylene terephthalate), are provided. The insulating property between the adjacent batteries 30 is enhanced.

Each of the batteries 30 has a box body of a thin rectangular parallelepiped shape, and the batteries 30 are stacked such that main surfaces face each other and are disposed approximately in parallel. On the upper surface of the box body of the battery 30, a negative terminal 50 is provided at one end side in the elongated direction, and a positive terminal 60 is provided at the other end side. Hereinafter, the negative terminal 50 and the positive terminal 60 are collectively referred to as outer terminals. The negative terminal 50 of one adjacent battery 30 and the positive terminal 60 of the other adjacent battery 30 are arranged so as to be close to each other. Thus, in the 2 adjacent batteries 30, the negative terminal 50 of the one adjacent battery 30 and the positive terminal 60 of the other adjacent battery 30 are electrically connected by the bus bar 40, and then the 12 pieces of the batteries 30 are connected in series.

The battery module 10 is stored in a housing case (not shown in the figures). The one end positive terminal 60′ of the series-connected batteries 30 and the other end negative terminal 50′ are connectable to an outer load (not shown in the figures) through wiring (not shown in the figures) led to the outside of the housing case

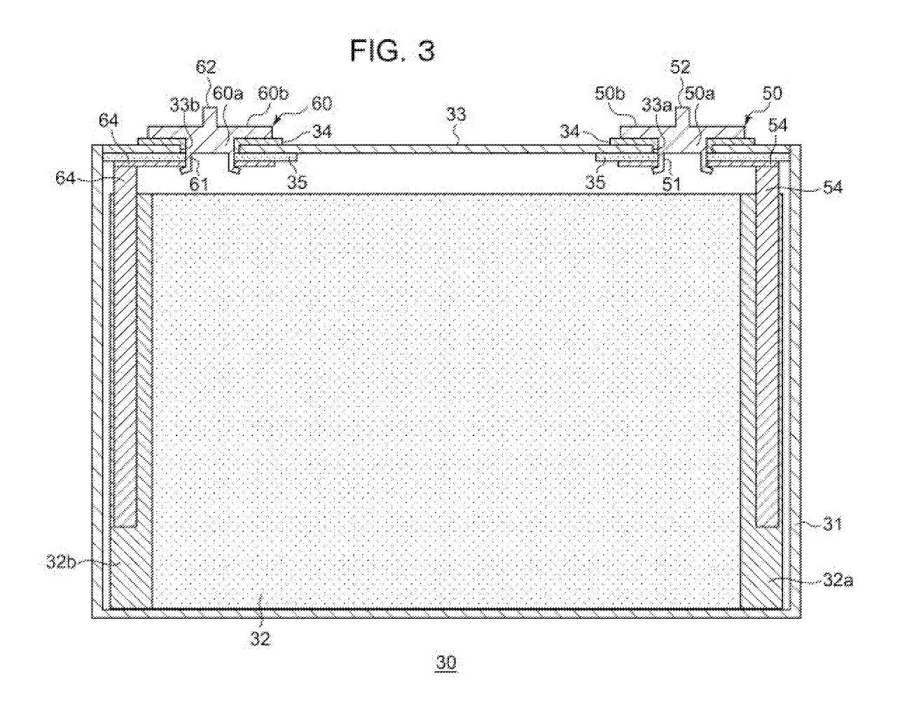

FIG. 3 is a sectional view showing a schematic structure of a battery. As shown in FIG. 3, in the battery 30, an electrode assembly 32 (axis) where positive and negative electrodes are wound in a spiral form, is stored in an outer can (box body) 31 in the direction transverse to the can axis. An opening of the outer can 31 is sealed by a sealing plate 33 configuring one part of the box body. The negative terminal 50 and the positive terminal 60 are provided at the sealing plate 33. Further, a gas exhaust valve (not shown in the figures) is formed at the sealing plate 33.

The negative terminal 50 has a main portion 50a and a flange portion 50b. The main portion 50a is approximately cylindrical, and the flange portion 50b of a disk shape is connected at one end portion disposed outside the box body in the main portion 50a. The main portion 50a of the negative terminal 50 is press-fitted into an opening 33a for the negative terminal in a state where the side surface of the main portion 50a contacts a gasket 34. The gasket 34 contacts also the surface of the flange portion 50b facing the sealing plate 33. Further, the main portion 50a is connected to a negative tab member 54 inside the battery of the sealing plate 33.

At the tip portion of the main potion 50a inside the battery, a concave portion 51 are provided so as to form a side wall along the opening 33a for the positive terminal. The concave portion 51 is caulked such that the edge portion of the concave portion 51 is made wide, and the negative terminal 50 is fixed to the negative tab member 54. A bolt 52 projecting upward is provided on the upper surface of the flange portion 50b.

An insulating board 35 is provided between the positive tab member 54 and the battery inner side of the sealing plate 33. In the opening 33a for the negative terminal, the insulating plate 35 contacts the gasket 34. By this, the negative tab member 54 and the negative terminal 50 are insulated from the sealing plate 33. The negative tab member 54 is connected to a negative current collector board group 32a. Here, the negative current collector board group 32a is a bundle of a plurality of the negative current collectors extended from one end surface of the electrode assembly 32.

The positive terminal 60 has a main portion 60a and a flange portion 60b. The main portion 60a is approximately cylindrical, and the flange portion 60b of a disk shape is connected at one end portion disposed outside the box body in the main portion 60a. The main portion 60a of the positive terminal 60 is press-fitted into an opening 33a for the positive terminal in a state where the side surface of the main portion 60a contacts a gasket 34. The gasket 34 contacts also the surface of the flange portion 60b facing the sealing plate 33. Further, the main portion 60a is connected to a positive tab member 64 inside the battery of the sealing plate 33.

At the tip portion of the main potion 60a inside the battery, a concave portion 61 are provided so as to form a side wall along the opening 33a for the positive terminal. The concave portion 61 is caulked such that the edge portion of the concave portion 61 is made wide, and the positive terminal 60 is fixed to the positive tab member 64. A bolt 62 projecting upward is provided on the upper surface of the flange portion 60b.

An insulating board 35 is provided between the positive tab member 64 and the battery inner side of the sealing plate 33. In the opening 33a for the positive terminal, the insulating plate 35 contacts the gasket 34. By this, the positive tab member 64 and the positive terminal 60 are insulated from the sealing plate 33. The positive tab member 64 is connected to a positive current collector board group 32a. Here, the positive current collector board group 32a is a bundle of a plurality of the positive current collectors extended from one end surface of the electrode assembly 32.

The bus bar 40 is made of conductive material such as metal, and is of a belt shape. In the 2 adjacent batteries 30, a bolt 52 (refer to FIG. 1) of the one battery 30 passes one through hole of the bus bar 40, and is screwed into a nut (not shown in the figures), and then the bus bar 40 and the negative terminal 50 are physically, electrically connected. Further, a bolt 62 (refer to FIG. 1) of the other battery 30 passes the other through hole of the bus bar 40, and is screwed into a nut (not shown in the figures), and then the bus bar 40 and the positive terminal 60 are physically, electrically connected.

A pair of the end plates 80a, 80b are disposed at both ends of the stacked direction of the plurality of the batteries 30.

The binding bars 90a-d as the binding member are provided such that the corresponding four corners in each of the end plate 80a, 80b are compressed by the binding bars 90a-d.

In the present embodiment, one end portion of the binding bar 90 is fixed by screws 92a at the corner portion of the outer surface in the end plate 80a, and the other end portion of the binding bar 90 is fixed by screws 92b at the corner portion of the outer surface in the end plate 80b.

In the battery module 10 of this embodiment, when temperature changes from 30° C. to −30° C., the binding bar 90 has larger compressed size change ΔL per unit length in the elongated direction than compressed size change ΔS per unit length in the stacked direction in the stacked member including the batteries 30. Here, the stacked member including the batteries 30 includes the plurality of the batteries, the separators 70 provided between the adjacent batteries 30, and the pair of the end plate 80a, 80b.

Here, each of the batteries 30 may be covered with insulating film. In this case, the insulating film is included in the stacked member, and the thickness of the insulating film is a part of the thickness of the stacked member.

Material of the end plate 80 or the binding bar 90 is not limited to specific one as long as a relation of the compressed size change ΔL>the compressed size change AS is satisfied in the case where the temperature changes from 30° C. to 30° C. For example, the end plate 80 is made of steel or aluminum. Further, the binding bar 90 is made of steel or stainless steel. Here, when the relation of the compressed size change ΔL>the compressed size change AS is satisfied, the end plate 80 and the binding bar 90 may be made of a common material. Especially, as stainless steel based materials such as SUS410 or SUS304 comparatively have wide range values in thermal expansion coefficient, the compressed size change can be determined by selecting which material in the stainless steel-based materials is used as a specific part. Here, in the typical range of the thermal expansion coefficient in materials, steel based materials are 11.2 to 11.6×10⁻⁶, and stainless steel based materials are 9.9 to 17.3×10⁻⁶, and aluminum is 23.6×10⁻⁶, and a unit is 1/K. The thermal expansion coefficients of typical materials are shown in Table 1.

TABLE 1

| | linear expansion |
|---|---|
| material | coefficient (10⁻⁶/K) |
| Al alloy | 23.2 |
| Mg alloy | 27 |
| SS400 | 11.6 |
| S45C | 11.2 |
| SUS304 | 17.3 |
| SUS310 | 15.9 |
| SUS316 | 16 |
| SUS410 | 9.9 |
| SUS420 | 10.3 |
| SUS430 | 10.4 |
| SUS440 | 10.2 |
| SK105 | 13.5 |
| SUJ2 | 12 |

According to the battery module 10 explained above, as thermal contraction of the binding member (the binding bar 90) compensates for decrease of swelling strength of the stacked member at low temperature, binding strength to the stacked member by the binding member at low temperature is kept in the same extent as at normal temperature. As the result, vibration resistance can be improved under a low temperature condition at the time of starting the operation.

Conversely, at normal temperature, by thermal expansion of the binding member, it is suppressed that the stacked member is excessively bound, and then binding strength to the stacked member can be appropriately kept.

### (Evaluation of Changes in Size of Battery Module)

The plurality of the batteries constituting the battery module changes those sizes depending on states of charging rate (SOC) or degree of deterioration. In addition, the plurality of the batteries are bound by the binding bars in a compressed state at a predetermined size pressed by the end plates. Namely, in members constituting the battery module, sizes of the plurality of the batteries 30 are not decided by only temperature change. Concretely, the outer can of the battery is generally made of aluminum, and the electrode assembly is stored in the outer can. In a compressed state of the batteries at a predetermined size pressed by the end plates, the electrode assembly is in a resiliently deformed state. Additionally, the electrode assembly has properties that it expands as charging rate of the batteries 30 increases, or as the battery performance is degraded. Therefore, even at low temperature, by resilience in a resiliently deformed state and the expansion of the electrode assembly, strength is always added to the outer can in the expanding direction. Therefore, sizes of the batteries 30 constituting the battery module 10 of the above embodiment are not contracted simply depending on temperature change. Namely, since the batteries 30 are not influenced by temperature change, compared with the end plates or the binding bars, it is thought that sizes of the batteries do not substantially change. Therefore, members constituting the battery module are divided into three of the compressed member, the temperature deformed member, and the binding member. Concretely, the compressed member is corresponding to the plurality of the batteries 30 in the above embodiment, and the temperature deformed member is corresponding to the end plates 80 and the separators 70, and the binding member is corresponding to the binding bars 90. The inventors of the present invention found that the members constituting he battery module are divided into three of the compressed member, the temperature deformed member, and the binding member, and carried out the experiment based on the above prospect, and found that decrease in binding strength at low temperature is suppressed by properly selecting materials of he temperature deformed member and the binding member. Its experiment is explained below.

Here, measured, it is very difficult to measure size of the battery module while the temperature is precisely. Practically, by the experiments reproducing simulatively the battery module of the above embodiment, the experiments where relation of binding strength in the battery module and the temperature is measured are curried out.

### <Experimental Condition>

Enough time After the battery module is put in a constant temperature oven, binding strength of the battery module is evaluated. Here, a room temperature is 30° C., and changes in binding strength are plotted when temperature changes from 30° C. to 30° C.

In the battery modules used in the experimental example 1 and the experimental example 2, the number of the cell is one as the smallest unit, and the members corresponding to the end plates are disposed at both ends of the cell. The end plates disposed at both ends are bound by rods, and the cell is pressurized by the end plates, Here, for the convenience of measurement, the member corresponding to the end plate is divided into several members (temperature deformed member 1 to 4) as the members corresponding to the end plates. In the battery modules used in the experimental example 1 and the experimental example 2, the cell and measuring instrument is compressed member, and the rod is binding member, and other member is temperature deformed member.

Experimental condition of material and size in each member used at 30° C. is described in the following.

### <Experimental Example 1>

Material of temperature deformed member 1: S45C (carbon steel)
Thickness of temperature deformed member 1: 15 mm
Material of temperature deformed member 2: S45C (carbon steel)
Thickness of temperature deformed member 2: 18 mm
Material of temperature deformed member 3: Al alloy
Thickness of temperature deformed member 3: 15 mm
Material of temperature deformed member 4: SK105 (carbon steel)
Thickness of temperature deformed member 4: 15 mm
Material of binding member: SUS304
Thickness of binding member: 136.5 mm
<Experimental example 2>
Material of temperature deformed member 1: Al alloy
Thickness of temperature deformed member 1: 15 mm
Material of temperature deformed member 2: S45C (carbon steel)
Thickness of temperature deformed member 2: 18 mm
Material of temperature deformed member 3: Al alloy
Thickness of temperature deformed member 3: 15 mm
Material of temperature deformed member 4: SK105 (carbon steel)
Thickness of temperature deformed member 4: 15 mm
Material of binding member: S45C (carbon steel)
Thickness of binding member: 136.5 mm

Here, except for binding member material of S45C and temperature deformed member 1 material of Al alloy in the battery module of the experimental example 2, the battery module of the experimental example 2 has the same structure as the battery module of the experimental example 1. By comparing these, in order to satisfy the above relation of the compressed size change ΔL>the compressed size change AS, the compressed size changes can be substantially evaluated when material of the end plate or material of the binding bar is changed

By using material, size of member, change in temperature (60° C. in this experiment), and thermal expansion coefficient shown in Table 1, the compressed size change can be calculated

Concretely, the compressed size change ΔL is expressed in the following formula (1).

ΔL=α·L·ΔT (1)
L: length of member (mm)
ΔL: compressed size change (=shrunken size change) in member at temperature change of 60° C. (=60K)
ΔT: temperature change
α: thermal expansion coefficient (1K)

Therefore, compressed size change per unit temperature ΔL/ΔT mm/K) is expressed in the following formula (2).

ΔL/ΔT=α·L (2)

Here, in the member evaluated in this embodiment, as there is no temperature dependability of thermal expansion coefficient, the values as a constant value of Table 1 can be used. In the case where the member having temperature dependability of thermal expansion coefficient, the members in which the relation of the compressed size change ΔL>the compressed size change ΔS is satisfied, are selected in the temperature range of 50° C. to −50° C., preferably 30° C. to −30° C.

In each of the experimental example 1 and the experimental example 2, the compressed size change ΔL of the member corresponding to the binding bar, and the compressed size change of the member corresponding to the stacked member are calculated. The calculated values of the compressed size changes in the members are described below.

### <Experimental Example 1>

Compressed size change of temperature deformed members 1 to 4: 0.048 mm
Compressed size change of binding member: 0.142 mm

### <Experimental Example 2>

Compressed size change of temperature deformed members 1 to 4: 0.059 mm
Compressed size change of binding member: 0.092

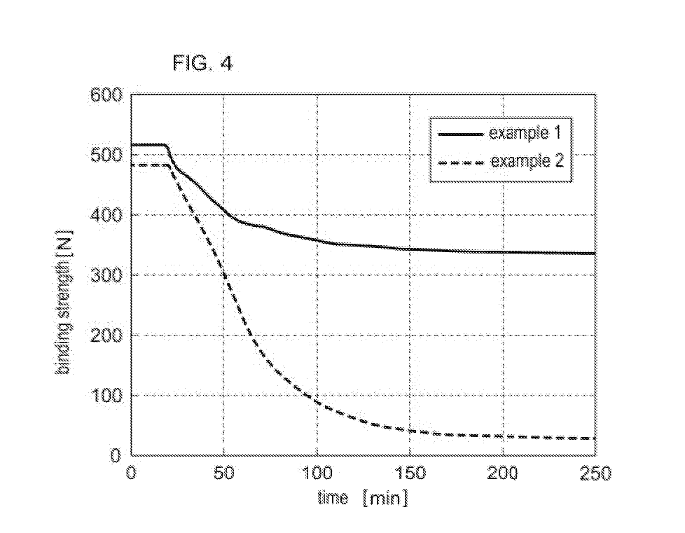

In the battery modules of the experimental example 1 and the experimental example 2, temperature is changed from 30° C. to −30° C. As shown in FIG. 4, at −30° C., binding strength of the experimental example 1 is approximately 3 times more than that of the experimental example 2. Therefore, the battery module of the experimental example 1 can keep adequate binding strength even at low temperature.

FIG. 4 is a graph showing changes in binding strength by binding bar when temperature is changed from 30° C. to −30° C. As shown in FIG. 4, in the battery module of the experimental example 2, as temperature decreases, the binding strength decreases widely, and is close to 0 N at −30° C. In contrast, in the battery module of the experimental example 1, even when temperature decreases, the binding strength is kept, and it is confirmed that the binding strength at −30° is kept to 70% of the binding strength at 30° C.

Here, the compressed size change in the above embodiment, does not mean real size change in the binding bar or the end plate, but expresses estimated theoretical value based on thermal expansion coefficient and size of member. It is a reason why the compressed size change does not necessarily coincide with real size change due to various factors such as temperature change, or elastic or resilient deformation in the real battery module, i

### REFERENCE MARKS IN THE DRAWINGS

10: battery module

30: battery

40: bus bar

70: separator

80: end plate

90: binding bar

1. A battery module comprising:
a stacked member containing a plurality of batteries stacked in one direction; and
a binding member for binding the stacked member in the stacked direction in a pressurized state,
further the stacked member comprising:
temperature deformed member of which size changes by change of temperature; and
compressed member bound by the binding member in a compressed state,
wherein in the temperature range of at least 30° C. to −30° C., the binding member has larger compressed size change per unit temperature of ΔL/ΔT in the stacked direction than compressed size change per unit temperature of ΔS/ΔT in the stacked direction in the temperature deformed member.

2. The battery module according to claim 1,
further the temperature deformed member comprising:
end plates disposed at both ends of the stacked member in the stacked direction; and
a separator disposed between the plurality of the batteries, and insulating the adjacent batteries from each other.

3. The battery module according to claim 1,
wherein the compressed member includes the plurality of the batteries.

4. The battery module according to claim 2,
wherein the end plate is made of the at least one type of material selected from Al alloy, Mg alloy, stainless steel, and steel, and the separator is made of the at least one type of material selected from PP and PBT.
